(19) United States
(12) Patent Application Publication
(10) Pub. No.: US 2008/0236217 A1
(43) Pub. Date: Oct. 2, 2008

(54) Antitheft Device For Locking a Vehicle Steering Wheel

(75) Inventor: Fiorenzo Ruffini, Morrovalle( Macerata) (IT)

Correspondence Address: WILLIAM J. SAPONE;COLEMAN SUDOL SAPONE P.C., 714 COLORADO AVENUE, BRIDGE PORT, CT, 06605, US

(73) Assignee: Tiziana Maricotti, Morrovalle (Macerata) (IT)

(21) Appl. No.: 11/577,802

(22) PCT Filed: Oct. 28, 2005
(86) PCT No.: PCT/IB2005/003215

§ 371 Date: Apr. 24, 2007

(30) Foreign Application Priority Data
Nov. 2, 2004 (IT) BO2004A 000677

(51) Int. Cl. B60R 25/02

(52) U.S. Cl. 70/209

(57) ABSTRACT

The proposed antitheft device (1) for locking the steering wheel (2) of an automobile includes a tubular element (3), having a recess (4) shaped in such a way, as to receive in a removable coupling a peripheral portion (2a) of the steering wheel (2). A pair of pins (5, 50) protrude from the tubular element (3), in a position corresponding to the recess (4), to hook the peripheral portion (2a) of the steering wheel (2). A cover (6) is connected to the tubular element (3), to close the recess (4), to allow the peripheral portion (2a) of the steering wheel (2) to be locked. Locking means (8) are connected to the cover (6), to stabilize the closing of the recess 4. A bar (9) translates inside the tubular element (3) from a first configuration (A), in which it covers the recess (4), making it inaccessible to the peripheral portion (2a) of the steering wheel (2), to a second configuration (B), in which it protrudes laterally with respect to the tubular element (3), making the recess (4) accessible, so as to receive the peripheral portion (2a) of the steering wheel (2).

### BACKGROUND OF THE INVENTION

The present invention relates to the technical field concerned with an antitheft devices for an automobile.

In the specific case, the present invention relates to a locking device for locking an automobile steering wheel.

### SHORT DESCRIPTION OF THE PRIOR ART

A number of mechanical antitheft devices for automobiles are particularly widespread on the market.

Their diffusion is connected substantially to the increase of thefts and always raising ability of thieves, who manage to overcome easily the difficulties created by electronic antitheft devices.

There are three different types of mechanical antitheft devices: the first one, which acts on the vehicle pedals, obstructing its correct use, the second one, which acts on the pedals and steering wheel, hindering the free use of the latter, and the last type, which acts only on the steering wheel, preventing and/or limiting the use of the steering wheel.

Most of known mechanical antitheft devices acting on the steering wheel belong to the type including a mechanical element, coupled diametrically with the steering wheel outer ring and having an element, which protrudes beyond the steering wheel.

In case of driving with the mechanical antitheft device in action, the dimensions of the protruding element make it interfere with the windscreen or the lateral door, or with the driver's legs, thus preventing a car correct driving.

This kind of antitheft device can be easily force opened by any bad-intentioned person, who, being equipped with its own tools, breaks a portion of the steering wheel outer ring, near the antitheft device, so as to remove the latter from the steering wheel.

Consequently, this kind of antitheft device is extremely inefficient with an bad-intentioned person with ordinary skill, and at the most it can act as deterrent for occasional, and/or little skilled, and/or without a sufficient equipment bad-intentioned people.

The document EP 0.701.933 describes an antitheft device for locking the steering wheel of an automobile, which includes:
an external tubular element, having a recess, shaped in such a way, as to couple with a steering wheel peripheral section, with the external tubular element protruding in such a way, as to interfere with a part of the vehicle and prevent free rotation of the steering wheel with the antitheft device in use;
an internal tubular element, rotating in said external tubular element, having a pair of protruding tabs, which are longitudinally spaced apart to hook the steering wheel radial stems, said inner tubular element being conceived in such a way that, due to the rotation in a first position, the antitheft device is in an open configuration, in which the steering wheel peripheral section can pass through the recess of the external tubular element and, due to the rotation in a second position, the antitheft device is in a locking configuration, in which the tabs lock the steering wheel peripheral section and prevent it from passing through the recess, out of the external tubular element; and
a locking group for stabilizing the antitheft device in the locked configuration.

In particular, the locking group, which allows to open/close the antitheft device, includes at least one security lock, which acts against a pin loaded by a spring, and engaged in a hole made in the inner tubular element.

The security lock is preferably situated at one end of the external tubular element.

The disadvantage of this antitheft device lies in big dimensions of the external tubular element, when not used, and in big weight of the whole antitheft device.

A so obtained structure, including an inner tubular element, which can rotate with respect to the external tubular element, is little resistant and can be easily force opened by an bad-intentioned person of medium ability.

### SUMMARY OF THE INVENTION

The object of the present invention is to avoid the above mentioned disadvantages by proposing a particularly efficient antitheft device for locking an automobile steering wheel, which ensures high reliability standard and functionality with any bad-intentioned person.

Another object of the present invention is to propose a particularly handy and strong antitheft device, of extremely contained weight, and whose dimensions can be particularly reduced, when it is not used.

The above mentioned objects are obtained in accordance with the contents of the claims.

The above mentioned objects are obtained in accordance with what is claimed, by the antitheft device for locking an automobile steering wheel, characterized in that it includes: a tubular element, having a recess shaped in such a way, as to receive in a removable coupling a peripheral portion of the steering wheel; at least one pin, protruding from said tubular element, in a position corresponding to the recess, to hook said peripheral portion of the steering wheel; a cover, connected to the tubular element and interacting with said protruding pin during at least partial closing of the recess, to allow the peripheral portion of the steering wheel to be locked; locking means, interacting with said pin to stabilize the closing of the recess by the cover; a bar, assuming a configuration of maximum longitudinal dimension of the antitheft device, in which it protrudes laterally with respect to the tubular element, so as to interfere with a part of vehicle, to prevent the steering wheel from freely rotating.

### BRIEF DESCRIPTION OF THE DRAWINGS

The characteristic features of the invention will be pointed out in the following description of some preferred, but not exclusive embodiments, with reference to the enclosed figures, in which:

FIGS. 1, 2 are as many schematic, front views, partially section and top, of the proposed antitheft device in a rest configuration;

FIGS. 3, 4 are schematic, front views, in different scale, of the antitheft device in subsequent use configurations;

FIGS. 5, 6 are as many schematic, especially enlarged, cross-section views of a particularly significant element in respective operation steps.

### DESCRIPTION OF PREFERRED EMBODIMENTS OF THE INVENTION

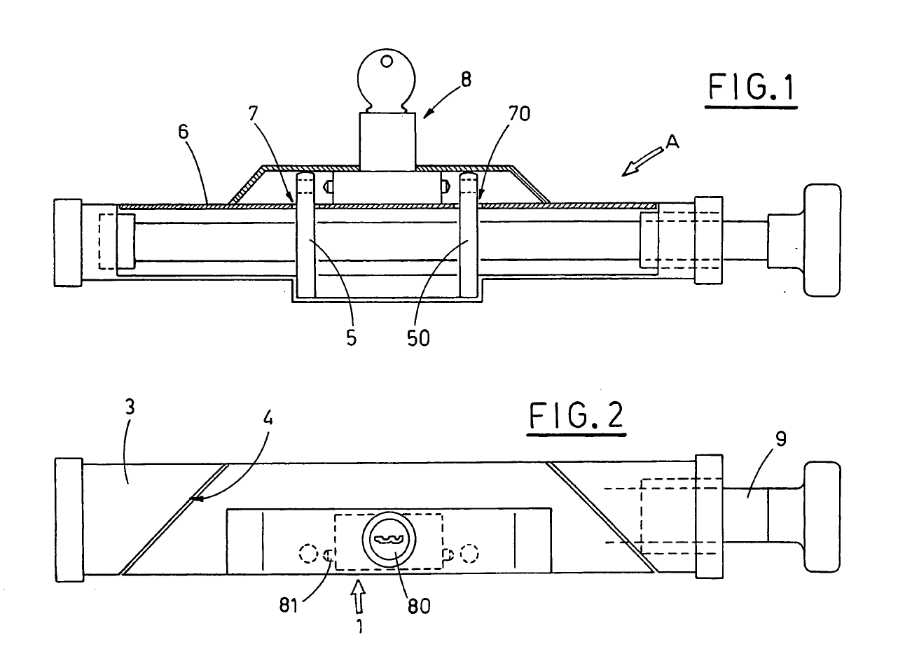

Having regards to the above mentioned Figures, the reference number 1 indicates the proposed antitheft device for locking a steering wheel 2 of an automobile, which includes: a tubular element 3, having a recess 4, shaped in such a way, as to receive, in a removable coupling, a peripheral portion 2a of the steering wheel 2; a pair of pins 5, 50, protruding from the tubular element 3, located in a region corresponding to the recess 4, longitudinally spaced apart and capable of hooking the peripheral portion 2a of the steering wheel 2, so as to be situated astride a radial arm 20 of the steering wheel 2; a cover 6, connected to the tubular element 3 and having a pair of through holes 7, 70, aimed at being passed through by the corresponding pins 5, 50 during at least partial closing of the recess 4, so as to allow the peripheral portion 2a of the steering wheel 2 to be locked, locking means 8 for stabilizing the closing of the recess 4 by the cover 6 (FIGS. 1, 2).

The proposed antitheft device 1 has also, situated at one of its ends, a bar 9, which can translate inside the tubular element 3 between corresponding extreme configurations A, B, of respectively minimum and maximum longitudinal dimension of the antitheft device 1.

Advantageously, there are means (not shown) for keeping the sliding bar 9 inside the tubular element 3, so as to prevent possible going out.

Likewise, there can be means (not shown) for stabilizing the configuration A, in which the antitheft device 1 has minimum longitudinal dimension.

In the configuration A of minimum longitudinal dimension, the bar 9 is located in a position corresponding to the recess 4, making it inaccessible to the peripheral portion 2a of the steering wheel 2, while in the configuration B of the maximum longitudinal dimension, the bar 9 protrudes laterally with respect to the tubular element 3, making the recess 4 accessible, for receiving the peripheral portion 2a of the steering wheel 2 (FIGS. 1, 2).

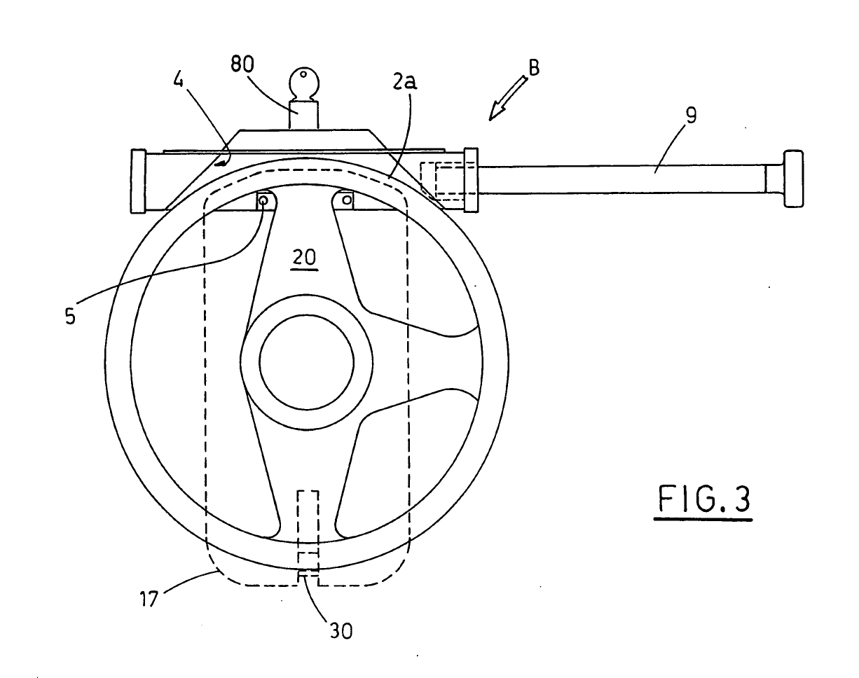

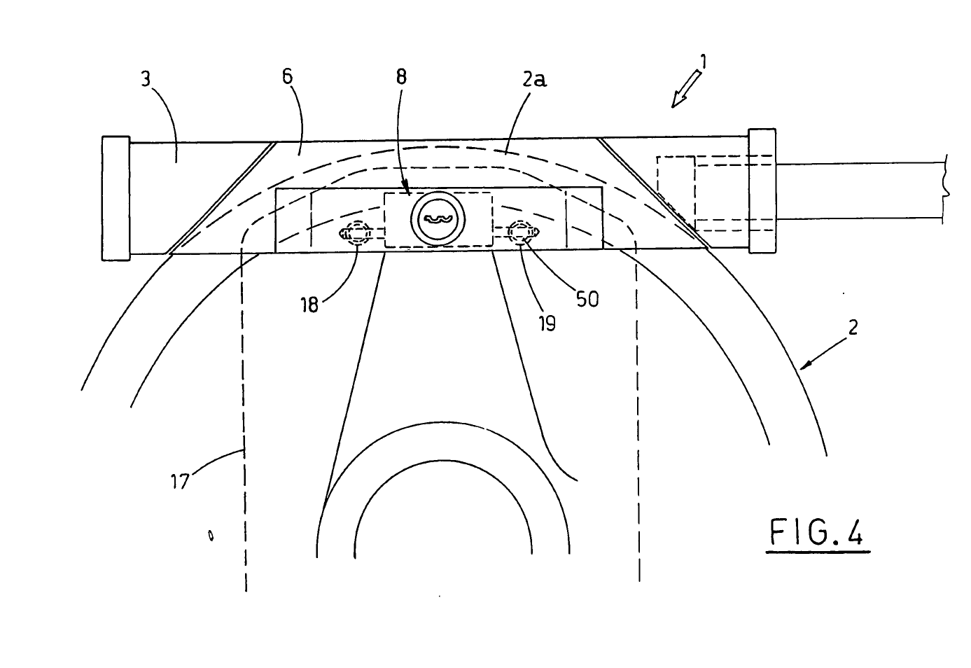

In configuration B, i.e. maximum longitudinal dimension, the bar 9 can go in abutment, with one end, against the peripheral portion 2a of the steering wheel 2 and protrude, so as to interfere with one part of the vehicle to prevent steering wheel 2 free rotation (FIGS. 3, 4).

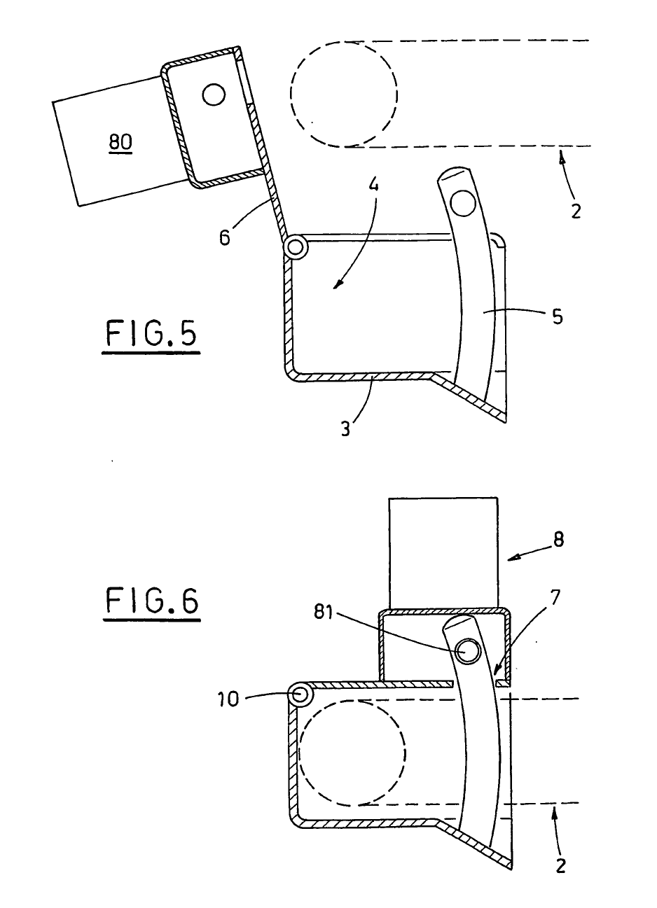

The cover 6 is preferably connected to the tubular element 3 by a hinge 10, situated e.g. at the part opposite to the locking means 8 (FIGS. 5, 6).

According to the characteristics, the hinge 10 can be positioned at an angle with respect to the extension of the tubular element 3, for example transversely (90°) or at a 45° angle.

In order to reduce the longitudinal dimension of the antitheft device 1 to a minimum, in non-use condition, the longitudinal extension of the tubular element 3 is substantially equal to the longitudinal extension of the sliding bar 9, to allow this latter to be contained in the tubular element 3 (FIGS. 1, 2).

For example, according to a preferred embodiment, each pin 5, 50 is made in one body with the tubular element 3 and has a curved shape (FIG. 5, 6).

According to another embodiment, each pin 5, 50 can be removably connected to the tubular element 3.

The locking means 8 include a security lock 80, connected to the cover 6, interacting with the respective pins 5, 50, made in the tubular element 3, by a pair of barrels 81 (FIGS. 1, 2).

Otherwise, according to another embodiment, (not shown), the security lock 80 is made at one end of the tubular element 3, to reduce the transversal dimension of the antitheft device 1, and interacts with the respective pins 5, 50 by a single, suitably shaped latch.

In the following, the operation of the proposed antitheft device 1 will be described, beginning from the minimum longitudinal dimension configuration A, in non-use condition, with the sliding bar 9 contained within the tubular element 3 and the cover 6 closed to hide partially the recess 4 (FIGS. 1, 2).

When it is necessary to select the use condition, the lock 80 is acted on, to disengage the cover 6 from the recess 4 and to allow the peripheral portion 2a of the steering wheel 2 to be introduced into the recess, taking care to place the pins 5, 50 astride of a wheel 2 radial arm 20 (FIGS. 3, 5).

The above mentioned introduction requires the positioning of the sliding bar 9 in the maximum longitudinal extension configuration B, with the inner end of the sliding bar set in abutment against the peripheral portion 2a of the steering wheel 2.

Afterwards, the cover 6 is operated to close partially the recess 4, so as to lock the peripheral portion 2a of the steering wheel 2 therein, and then the lock 80 is suitably manipulated to stabilize the closing (FIGS. 4, 6).

According to an interesting embodiment, the device can include a plate 17 (indicated with broken line in FIGS. 3, 4), having a pair of through holes 18, 19, aimed at being engaged by the protruding pins 5, 50 during the recess 4 closing action.

In particular, the plate 17 is interposed between the steering wheel 2 and the cover 6, in a position corresponding to the maximum longitudinal extension configuration B, so as to make the central area of the steering wheel 2 inaccessible.

This allows to prevent the airbag theft and/or damages, as well as possible non-authorized removals of the steering wheel 2.

Advantageously, the plate 17 includes means 30 for stabilizing the configuration of the plate with respect to the steering wheel 2, including e.g. a hook, aimed at coupling with the steering wheel 2, mounted on a slide, which glides on a sleeve, connected to the plate 17.

What above allows a stabilization of the plate 17 with respect to the steering wheel 2 independently from the radial dimensions of the latter.

According to a further embodiment (not shown), the bar 9 can be motionless with respect to the tubular element 3, in its configuration B of maximum longitudinal extension, thus maintaining the recess 4 always accessible to receive the peripheral portion 2a of the steering wheel 2.

It can be easily understood from the above description how the proposed antitheft device for locking the steering wheel of an automobile is particularly efficient, assuring high reliability and functional standards with any bad-intentioned person.

At the same time, the presence of a tubular element, inside which a sliding bar translates, allows to reduce the dimension during the antitheft device non-use step, as well as to maximize the longitudinal extension during the use step, for best interference of the bar with a part of the vehicle, to prevent the steering wheel from rotating freely.

It is also to be pointed out that the antitheft device proposed by the invention, characterized by extremely reduced weight, is particularly handy and strong.

It is understood that the proposed invention has been described, with reference to the enclosed figures, as a mere, not limiting example. Therefore, it is obvious that any changes or variants applied thereto remain within the protective scope defined by the following claims.

1. Antitheft device for locking the steering wheel of an automobile, characterized in that it includes: a tubular element (3), having a recess (4) shaped in such a way, as to receive in a removable coupling a peripheral portion (2a) of the steering wheel (2); at least one pin (5, 50), protruding from said tubular element (3), in a position corresponding to the recess (4), to hook said peripheral portion (2a) of the steering wheel (2); a cover (6), connected to the tubular element (3) and interacting with said protruding pin (5, 50) during at least partial closing of the recess (4), to allow the peripheral portion (2a) of the steering wheel (2) to be locked; locking means (8), interacting with said pin (5, 50) to stabilize the closing of the recess 4 by the cover (6); a bar (9), assuming a configuration of maximum longitudinal dimension of the antitheft device (1), in which it protrudes laterally with respect to the tubular element (3), so as to interfere with a part of vehicle, to prevent the steering wheel (2) from freely rotating.

2. Antitheft device, as claimed in claim 1, characterized in that said bar (9) slides and can translate within the tubular element (3) from a minimum longitudinal dimension configuration (A) of the antitheft device (1), in which the bar covers the recess (4), making it inaccessible to the peripheral portion (2a) of the steering wheel (2), to a maximum longitudinal dimension configuration (B) of the antitheft device (1), in which the bar makes the recess (4) accessible, so that it receives said peripheral portion (2a) and goes in abutment against the peripheral portion (2a) of the steering wheel (2).

3. Antitheft device, as claimed in claim 2, characterized in that the longitudinal extension of the tubular element (3) is substantially equal to the longitudinal extension of the sliding bar (9), to allow the latter to be partially contained therein, when in the minimum longitudinal dimension configuration (A).

4. Antitheft device, as claimed in claim 2, characterized in that it includes means for stabilizing said minimum longitudinal dimension configuration (A) of the antitheft device (1).

5. Antitheft device, as claimed in claim 2, characterized in that it includes means for keeping the sliding bar (9) inside said tubular element (3) and preventing the bar from leaving the tubular element.

6. Antitheft device, as claimed in claim 1, characterized in that said bar (9) is motionless with respect to the tubular element (3).

7. Antitheft device, as claimed in claim 6, characterized in that said bar (9) is made in one body with the tubular element (3).

8. Antitheft device, as claimed in claim 1 characterized in that said cover (6) is connected to the tubular element (3) by a hinge (10).

9. Antitheft device, as claimed in claim 8, characterized in that said hinge (10) is positioned angularly with respect to the extension of the tubular element (3).

10. Antitheft device, as claimed in claim 1, characterized in that it includes a plate (17), having a through hole (18, 19), which engages with said protruding pin (5, 50) during at least partial closing of the recess (4) and in that said plate (17) is introduced between the steering wheel (2) and the cover (6) in a position corresponding to the maximum longitudinal dimension configuration (B) of the antitheft device (1).

11. Antitheft device, as claimed in claim 10, characterized in that it includes means (30) for stabilizing the configuration of the plate (17) with respect to the steering wheel (2).

12. Antitheft device, as claimed in claim 11, characterized in that said stabilizing means (30) include a hook, which couples with the steering wheel (2), and which is carried by a slide, which glides on a sleeve, connected to the plate (17).

13. Antitheft device, as claimed in claim 1, characterized in that said pin (5, 50) is integral with the tubular element (3).

14. Antitheft device, as claimed in claim 1, characterized in that said pin (5, 50) is connected removably with the tubular element (3).

15. Antitheft device, as claimed in claim 1, characterized in that said pin (5, 50) has a curved shape.

16. Antitheft device, as claimed in claim 1, characterized in that it includes a through hole (7, 70), made in said cover (6) and engaging with the said protruding pin (5, 50) during at least partial closing of the recess (4).

17. Antitheft device, as claimed in claim 1, characterized in that it includes a pair of pins (5, 50), protruding from said tubular element (3), longitudinally spaced apart and hooking a radial arm (20) of the steering wheel (2).

18. Antitheft device, as claimed in claim 1, characterized in that said locking means (8) include at least one security lock (80), which interacts with said pins (5, 50) made in said tubular element (3), by relative tightening means.

19. Antitheft device, as claimed in claim 18, characterized in that said security lock (80) is connected to the cover (6).

20. Antitheft device, as claimed in claim 18, characterized in that said security lock (80) is situated at one end of the tubular element (3).

21. Antitheft device, as claimed in claim 3, characterized in that it includes means for stabilizing said minimum longitudinal dimension configuration (A) of the antitheft device (1).

22. Antitheft device, as claimed in claim 3, characterized in that it includes means for keeping the sliding bar (9) inside said tubular element (3) and preventing the bar from leaving the tubular element.

23. Antitheft device, as claimed in claim 4, characterized in that it includes means for keeping the sliding bar (9) inside said tubular element (3) and preventing the bar from leaving the tubular element.
